(19) United States
(12) Patent Application Publication
(10) Pub. No.: US 2005/0093342 A1
(43) Pub. Date: May 5, 2005

(54) Overslam bumper for vehicle tailgate

(75) Inventor: Tae-Sok Kim, Seoul (KR)

Correspondence Address: PETER F. CORLESS;EDWARD & ANGELL, LLP, P.O.BOX 55874, BOSTON, MA, 02205, US

(73) Assignee: Kia Motors Corporation, Seoul (KR)

(21) Appl. No.: 10/977,956

(22) Filed: Oct. 29, 2004

(30) Foreign Application Priority Data
Nov. 1, 2003 (KR) 10-2003-0077143

(51) Int. Cl. B60J 5/00

(52) U.S. Cl. 296/207

(57) ABSTRACT

An overslam bumper for a vehicle tailgate comprising a protrusion installed at a tailgate is disclosed. A stopper member is installed at a vehicle body to contact the protrusion when the tailgate closes. The stopper member preferably integrally includes a contact part and side fixing part, wherein the contact part is configured to contact the protrusion when the tailgate closes, and the side fixing part preferably is protrusively formed to forcibly press a lateral side of the protrusion. The contact part of the stopper member preferably deforms when the tailgate closes to thereby absorb impact shock, minimize impact noise, and avoid excessive insertion of the tailgate. The side fixing part also preferably forcibly presses a lateral side of the protrusion, thereby avoiding disalignment of the tailgate.

### CROSS-REFERENCE TO RELATED APPLICATIONS

The present application is based on, and claims priority from, Korean Application Serial Number 10-2003-0077143, filed on Nov. 1, 2003, the disclosure of which is hereby incorporated by reference herein in its entirety.

### FIELD OF THE INVENTION

The present invention relates in general to a swing-up tailgate. More particularly, the present invention relates to an overslam bumper for a vehicle swing-up tailgate adapted to absorb impact upon closure of the tailgate, avoiding the tailgate from being excessively inserted into the vehicle body, and effectively avoiding disalignment of the tailgate.

### BACKGROUND OF THE INVENTION

Generally, sport utility vehicles, vans and the like are equipped with a tailgate at the rear end thereof to easily load or unload objects into the vehicles. The vehicles having the tailgate typically include an overslam bumper to absorb impact shock upon closure of the tailgate and to prevent the tailgate from being excessively inserted into the vehicle body.

However, when the tailgate is in a closed state, in order to prevent disalignment of the tailgate in relation to the vehicle body, certain supplementary guide bumper and body guide have been mounted at the vehicle body and tailgate.

### SUMMARY OF THE INVENTION

In one aspect, the present invention provides systems and methods to prevent or avoid disalignment of a tailgate without a supplemental guide bumper and body guide at the vehicle body and tailgate. The present invention can further assist in absorbing impact generated when closing the tailgate, minimizing impact noise, and avoiding the tailgate from being excessively inserted into the vehicle body.

Systems of the invention can provide a simple assembly and cost savings due to a reduction of components in comparison with conventional tailgate systems, which requires a supplemental guide bumper and body guide.

In preferred aspects, the invention includes an overslam bumper for a vehicle tailgate that comprises a protrusion installed at an inner panel of a tailgate. A stopper member is preferably equipped at a vehicle body to contact the protrusion when the tailgate closes. The stopper member preferably includes a contact part and side fixing part. The contact part suitably forms a vertical surface with regard to the insertion direction of the protrusion and touches the protrusion when the tailgate closes. The side fixing part suitably protrudes out from the contact part toward an opposite side of the insertion direction of the protrusion. When the protrusion presses the contact part, the side fixing part is preferably configured to deform to forcibly press a lateral side of the protrusion.

It is understood that the term “vehicle” or other similar term as used herein is inclusive of motor vehicles in general such as passenger automobiles, buses, trucks, various commercial vehicles, and the like. Preferred vehicles employed in systems of the invention include sport utility vehicles, vans and other motor vehicles which include a tailgate.

Other aspects of the invention are discussed below.

### BRIEF DESCRIPTION OF THE DRAWINGS

For a better understanding of the nature and objects of the present invention, reference should be made to the following detailed description, read in conjunction with the accompanying drawings, in which:

FIG. 1 illustrates an overslam bumper for a vehicle tailgate according to an embodiment of the present invention;

FIG. 2 is a perspective view of a stopper member;

FIG. 3 illustrates a stopper member when installed at one side of a vehicle body; and

FIG. 4 illustrates a state of a tailgate being closed compared to FIG. 1.

### DETAILED DESCRIPTION OF THE PREFERRED EMBODIMENTS

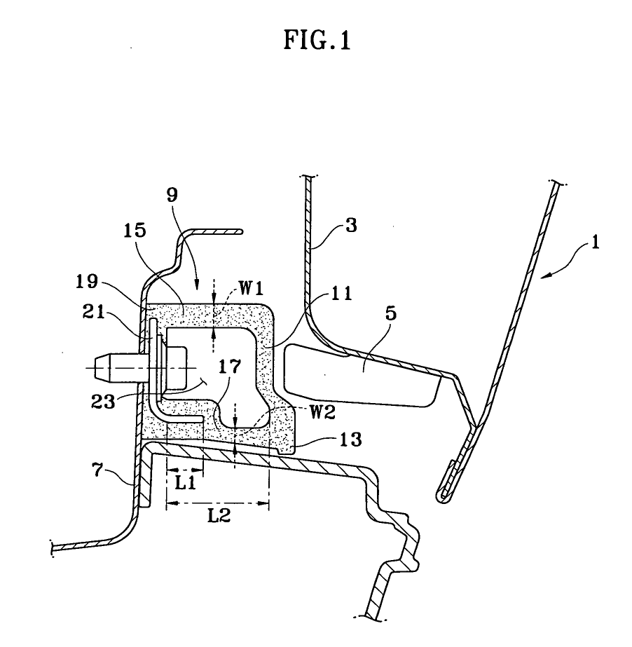

Referring now to FIG. 1, an overslam bumper for a vehicle tailgate is shown having a protrusion 5 at an inner panel 3 of a tailgate 1. A stopper member 9 is installed at a vehicle body 7 to contact the protrusion 5 when the tailgate 1 closes.

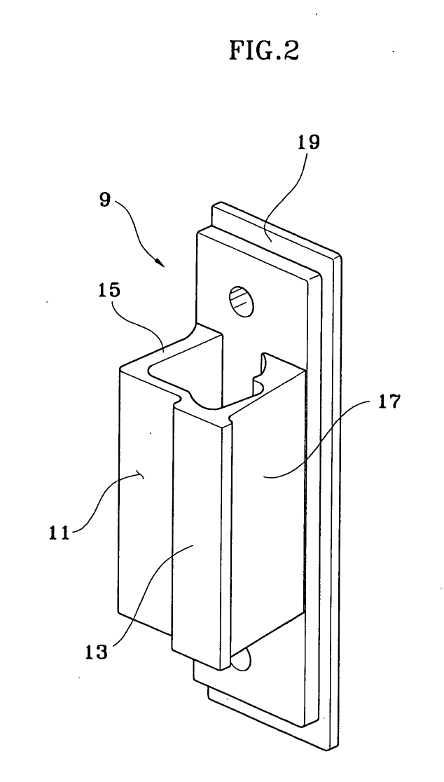

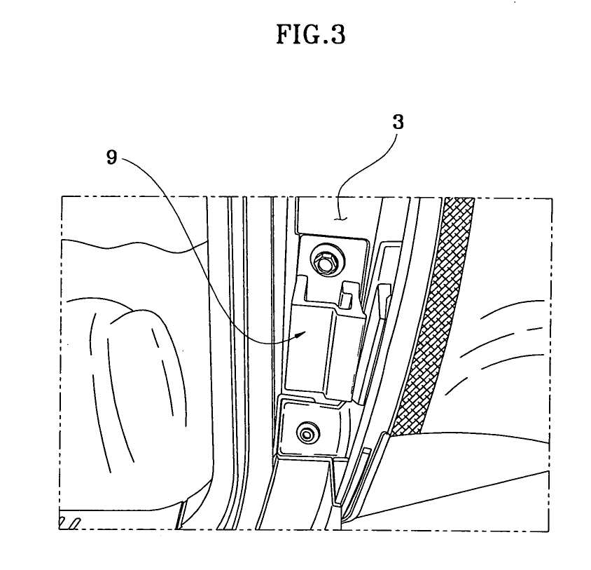

A detailed configuration of the stopper member 9 is illustrated in FIG. 2 and an installation state of the stopper member 9 at the vehicle body is illustrated in FIG. 3.

The stopper member 9 includes a contact part 11 and side fixing part 13. The contact part 11 forms a vertical surface in relation to the insertion direction of the protrusion 5 and contacts with the protrusion 5 when the tailgate 1 closes. The side fixing part 13 protrudes out from the contact part 11 toward an opposite side of the insertion direction of the protrusion 5 such that when the protrusion 5 presses the contact part 11, the side fixing part 13 deforms to forcibly press a lateral side of the protrusion 5.

The stopper member 9 further comprises an inner wall 15 extending out from the contact part 11 toward the vehicle body 7. An outer wall 17 extends from the side fixing part 13 toward the vehicle body 7. A vehicle body fixing part 19 vertically connects with the inner wall 15 and outer wall 17 and forms a sealed area 23 with the inner wall 15, outer wall 17, contact part 11 and side fixing part 13. The vehicle body fixing part 19 is affixed to the vehicle body 7, forming a surface-contacting relationship.

The stopper member 9 is typically made of rubber, and a metal piece 21 is inserted into the vehicle body fixing part 19 so as to be firmly fixed to the vehicle body 7.

The metal piece 21 is bent and extends from the inner side of the vehicle body fixing part 19 to the inner side of the outer wall 17 as shown in FIG. 1. The length of the metal piece 21 in the outer wall 17 (i.e., L1) is within a half range of L2, which represents the length of the outer wall 17.

The thickness of the inner wall 15, W1, is preferably largely formed compared to the minimum thickness of the outer wall 17 (i.e., W2). Therefore, when the protrusion 5 presses the contact part 11, the shape of the outer wall 17 deforms more than that of the inner wall 15 for allowing the side fixing part 13 to forcibly press against a lateral side of the protrusion 5.

The configuration of the sealed area 23, protrusively expanding toward the side fixing part 13, also allows the side fixing part 13 to easily deform to forcibly press the lateral side of the protrusion 5, when the protrusion 5 presses the contact part 11.

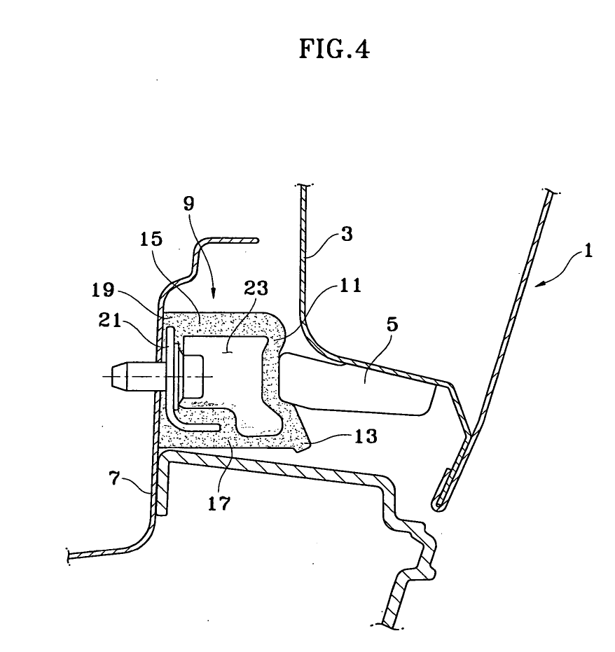

FIG. 1 depicts a state just before the protrusion 5 of the tailgate 1 touches the stopper member 9, when the tailgate 1 closes. FIG. 4 depicts a state of the deformed stopper member 9 when the protrusion 5 is in contact with the contact part 11 of the stopper member 9.

While the tailgate 1 closes, the stopper member 9 deforms from the state of FIG. 1 to FIG. 4 to absorb impact shock generated when closing the tailgate 1, minimize impact noise, and prevent or avoid excessive insertion of the tailgate into the vehicle body 7.

Thus, the side fixing part 13 of the stopper member 9 deforms as illustrated in FIG. 4 to forcibly press against a lateral side of the protrusion 5.

Since the overslam bumper including the stopper member 9 and protrusion 5 is symmetrically equipped at both sides of the vehicle body 7, when the side fixing part 13 of the stopper member 9 forcibly presses a lateral side of the protrusion 5, the tailgate 1 receives a pushing force from both sides of the vehicle toward the center thereof, thus preventing disalignment of the tailgate 1 mounted with the protrusion 5.

As apparent from the foregoing there is an advantage in that the contact part closely contacting the protrusion deforms by being inwardly pressed, when the tailgate closes, thereby absorbing impact shock, minimizing the impact noise, and preventing an excessive insertion of the tailgate.

There is another advantage in that the side fixing part is preferably configured to forcibly press a lateral side of the protrusion according to the deformation of the contact part, thereby avoiding potential disalignment of the tailgate.

Additionally, the assembly is simplified and the manufacturing cost is reduced due to a reduction of components in comparison to conventional systems requiring a supplementary guide bumper and body guide.

While the invention has been described with reference to specific embodiments, modifications and variations of the invention may be constructed with departing from the scope of the invention, which is defined in the following claims.

1. An overslam bumper for a vehicle tailgate, the bumper comprising:
a protrusion at an inner panel of a tailgate; and
a stopper member at a vehicle body to contact the protrusion when the tailgate closes, wherein the stopper member includes a contact part and side fixing part, the contact part forming a vertical surface in relation to the insertion direction of the protrusion and touching the protrusion when said tailgate closes,
the side fixing part protruding from the contact part toward an opposite side of the insertion direction of the protrusion whereby the protrusion presses the contact part, the side fixing part is configured to deform to forcibly press against a lateral side of said protrusion.

2. The bumper as defined in claim 1, wherein the stopper member further comprises:
an inner wall extending from the contact part toward said vehicle body;
an outer wall extending from the side fixing part toward said vehicle body; and
a vehicle body fixing part vertically connecting with the inner wall and outer wall, the vehicle body fixing part forming a sealed area with the inner wall, the outer wall, the contact part, and the side fixing part, and the vehicle body fixing part being affixed to the vehicle body, forming a surface-contacting relationship, and the stopper member is made of rubber.

3. The bumper as defined in claim 2, wherein a metal piece is inserted into the vehicle body fixing part.

4. The bumper as defined in claim 3, wherein the metal piece is bent and extends from the inner side of the vehicle body fixing part to the inner side of the outer wall, and the length of the metal piece in the outer wall is within a half range of the length of said outer wall.

5. The bumper as defined in claim 2, wherein the thickness of the inner wall is formed to be larger than the minimum thickness of the outer wall.

6. The bumper as defined in claim 2, wherein the sealed area protrusively expands toward the side fixing part.
